(19) United States
(12) Patent Application Publication
(10) Pub. No.: US 2025/0175987 A1
(43) Pub. Date: May 29, 2025

(54) INFORMATION CONFIGURATION METHOD AND APPARATUS, TERMINAL, NETWORK SIDE DEVICE, AND READABLE STORAGE MEDIUM

(71) Applicant: VIVO MOBILE COMMUNICATION CO., LTD., Dongguan (CN)

(72) Inventors: Chaojun ZENG, Dongguan (CN); Lihui WANG, Dongguan (CN)

(73) Assignee: VIVO MOBILE COMMUNICATION CO., LTD., Dongguan (CN)

(21) Appl. No.: 19/034,547

(22) Filed: Jan. 22, 2025

Related U.S. Application Data
(63) Continuation of application No. PCT/CN2023/107885, filed on Jul. 18, 2023.

(30) Foreign Application Priority Data
Jul. 25, 2022 (CN) 202210877636.9

(51) Int. Cl. H04W 72/21; H04W 56/00; H04W 72/0446; H04W 72/231

(52) U.S. Cl. CPC H04W 72/21; H04W 56/0015; H04W 72/0446; H04W 72/231

(57) ABSTRACT

This application provides an information configuration method and apparatus, a terminal, a network side device, and a readable storage medium. The information configuration method includes: receiving, by a terminal, first configuration information from a network side device. In the first configuration information, at most M sets of configuration information are configured for a single Physical Uplink Control Channel (PUCCH) resource, and each set of configuration information corresponds to a time domain unit meeting a specific requirement. The first configuration information includes at most N PUCCH configurations, and each PUCCH configuration corresponds to a time domain unit meeting a specific requirement. M is an integer greater than 1, and N is an integer greater than 1.

### CROSS-REFERENCE TO RELATED APPLICATIONS

This application is a continuation of International Application No. PCT/CN 2023/107885, filed on Jul. 18, 2023, which claims priority to Chinese Patent Application No. 202210877636.9, filed on Jul. 25, 2022. The entire contents of each of the above-referenced applications are expressly incorporated herein by reference.

### TECHNICAL FIELD

This application belongs to the field of communication technologies, and in particular, to an information configuration method and apparatus, a terminal, a network side device, and a readable storage medium.

### BACKGROUND

To make more flexible use of limited spectrum resources, dynamically match service requirements, and improve resource utilization efficiency and data transmission performance such as uplink coverage and delay, a flexible duplex mode is currently proposed. The flexible duplex mode is: full duplex on a network side, that is, uplink transmission and downlink transmission may be performed at different frequency domain locations at the same time; and half duplex on a terminal side, that is, being consistent with Time Division Duplex (TDD), and at the same time, only uplink transmission or downlink transmission can be performed, and they cannot be performed simultaneously. In the flexible duplex mode, there are available uplink resources in both of a downlink symbol and an uplink symbol of a TDD frame structure, but available bandwidths, generated/received interference, etc., corresponding to these two kinds of uplink resources are all different, and requirements for Physical Uplink Control Channel (PUCCH) transmissions are different. If a PUCCH transmission is performed based on the same configuration, performance of the PUCCH transmission may be affected.

### SUMMARY

Embodiments of this application provide an information configuration method and apparatus, a terminal, a network side device, and a readable storage medium.

According to a first aspect, an information configuration method is provided, including:

receiving, by a terminal, first configuration information from a network side device, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a second aspect, an information configuration method is provided, including:

sending, by a network side device, first configuration information to a terminal, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a third aspect, an information configuration apparatus is provided and applied to a terminal, including:

a receiving module, configured to receive first configuration information from a network side device, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a fourth aspect, an information configuration apparatus is provided, applied to a network side device and including:

a sending module, configured to send first configuration information to a terminal, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the communication interface is configured to receive first configuration information from a network side device, where in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface, where the communication interface is configured to send first configuration information to a terminal; and in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

According to a ninth aspect, a communication system is provided, including a terminal and a network side device. The terminal may be configured to perform the steps of the information configuration method according to the first aspect, and the network side device may be configured to perform the steps of the information configuration method according to the second aspect.

According to a tenth aspect, a readable storage medium is provided, where the readable storage medium stores a program or an instruction, and the program or the instruction is executed by a processor to implement the steps of the method according to the first aspect or the steps of the method according to the second aspect.

According to an eleventh aspect, a chip is provided, where the chip includes a processor and a communication interface, the communication interface is coupled to the processor, and the processor is configured to run a program or an instruction, to implement the steps of the method according to the first aspect or the steps of the method according to the second aspect.

According to a twelfth aspect, a computer program/program product is provided, where the computer program/program product is stored in a storage medium, and the computer program/program product is executed by at least one processor to implement the steps of the method according to the first aspect or the steps of the method according to the second aspect.

In the embodiments of this application, the terminal may receive first configuration information from the network side device; and in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement. Therefore, for PUCCH transmission, parameters that match related characteristics of different uplink resources can be configured for the different uplink resources, such as a time-frequency location, a code rate, a power, and the like, to make full use of the uplink resources based on the characteristics of the different uplink resources and ensure performance of PUCCH transmission.

### BRIEF DESCRIPTION OF DRAWINGS

FIG. 1 is a block diagram of a wireless communication system to which the embodiments of this application are applicable;

FIG. 2 is a schematic diagram of a flexible duplex mode according to an embodiment of this application;

FIG. 3 is a flowchart of an information configuration method according to an embodiment of this application;

FIG. 4 is a flowchart of another information configuration method according to an embodiment of this application;

FIG. 5 is a schematic diagram of a structure of an information configuration apparatus according to an embodiment of this application;

FIG. 6 is a schematic diagram of a structure of another information configuration apparatus according to an embodiment of this application;

FIG. 7 is a schematic diagram of a structure of a communication device according to an embodiment of this application;

FIG. 8 is a schematic diagram of a structure of a terminal according to an embodiment of this application; and

FIG. 9 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

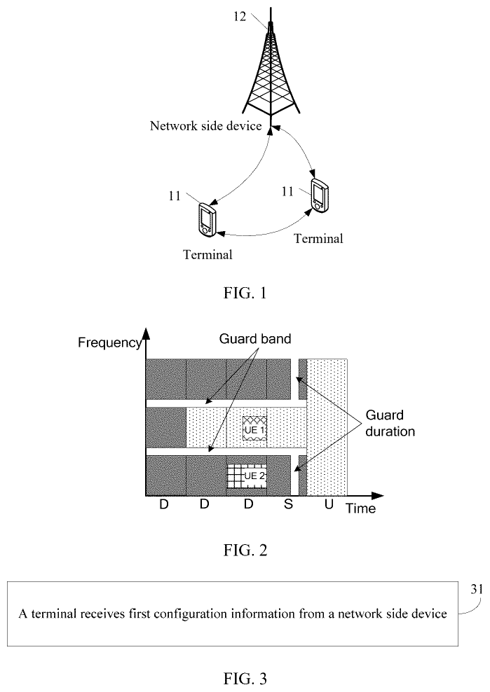

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station.

In order to better understand embodiments of this application, the following content is first described.

When a traditional cellular network is deployed, Frequency Division Duplex (FDD) or Time Division Duplex (TDD) may be used based on an available spectrum, a service characteristic, and the like. When the FDD mode is used, uplink transmission and downlink transmission are located at different frequencies, do not interfere with each other, and can be performed at the same time. When the TDD mode is used, uplink transmission and downlink transmission are located at the same frequency, and are performed in turns in a time division manner. The two duplex modes have their own advantages and disadvantages.

To make more flexible use of limited spectrum resources, dynamically match service requirements, and improve resource utilization efficiency and data transmission performance such as uplink coverage and delay, a flexible duplex mode is proposed. The flexible duplex mode may be referred to as a non-overlapping sub-band full duplex (SBFD) manner. The SBFD is: full duplex on a network side, that is, uplink transmission and downlink transmission may be performed at different frequency domain locations at the same time, and to avoid interference between uplink and downlink, a specific guard band may be reserved between frequency domain locations (corresponding to duplex sub-bands) corresponding to different transmission directions; and half duplex on a terminal side, that is, being consistent with time division duplex (TDD), and only one of uplink transmission or downlink transmission can be performed at the same time. It can be understood that in this duplex mode, uplink transmission and downlink transmission on the network side can only be for different terminals at the same time.

As shown in FIG. 2, FIG. 2 shows a schematic diagram of the flexible duplex mode. A network side device semi-statically divides a frequency domain of a single carrier into three duplex sub-bands within some downlink symbols, in which both sides of the carrier are downlink duplex sub-bands, and the middle is an uplink duplex sub-band, to reduce interference to adjacent carriers. In a 3^{rd} slot, UE 1 and UE 2 respectively perform uplink transmission and downlink reception.

For example, when a cell (such as an NR cell) is deployed on an asymmetric spectrum, the TDD mode is usually used. In this case, a TDD uplink and downlink common configuration TDD-UL-DL-ConfigCommon may be configured in a cell common parameter, to indicate information about a TDD frame structure, including a TDD frame cycle, a quantity of complete downlink/uplink slots included in a single frame cycle, a quantity of downlink/uplink symbols that are included in addition to the complete downlink/uplink slots, and the like. For example, a TDD uplink and downlink dedicated configuration TDD-UL-DL-ConfigDedicated may be independently configured for each terminal by using Radio Resource Control (RRC) signaling, to further modify an uplink and downlink symbol configuration of one or more slots in a single frame cycle on the basis of TDD-UL-DL-ConfigCommon, that is, an initial value of the uplink and downlink symbol configuration of the slot is specified by TDD-UL-DL-ConfigCommon, and is further modified by TDD-UL-DL-ConfigDedicated. This modification is only applied to a terminal receiving this RRC signaling. However, the modification herein is only limited to further indicating a flexible symbol in the slot as a downlink symbol (DL symbol) or an uplink symbol (UL symbol), and the DL/UL symbol in the slot cannot be modified to another direction. The flexible symbol is a symbol with an unclear transmission direction, and it may be subsequently determined as required whether to use it for downlink transmission or uplink transmission.

The TDD-UL-DL-ConfigCommon and/or TDD-UL-DL-ConfigDedicated are optional configurations. Because these pieces of configuration information can be semi-statically configured/modified based on only RRC signaling, each symbol in a single TDD frame cycle determined based on these pieces of configuration information, combined with a configured transmission direction, is referred to as a semi-static DL/UL/flexible symbol in the following. In addition, the symbol may be further abstracted into a time domain unit, and the time domain unit may correspond to a slot, a symbol, or the like. In this way, a single TDD frame cycle may include a plurality of semi-static DL/UL/flexible time domain units based on the configuration information. When the TDD-UL-DL-ConfigCommon and TDD-UL-DL-ConfigDedicated are not configured, there is no clear concept of TDD frame cycle. In this case, each slot/symbol in each radio frame of the NR cell can be understood as a semi-static flexible slot/symbol, or abstracted into a semi-static flexible time domain unit.

In the flexible duplex mode, there are available uplink resources in both of a downlink symbol and an uplink symbol of a TDD frame structure, but corresponding available bandwidths and generated/received interference are all different for the two uplink resources. For Physical Uplink Control Channel (PUCCH) transmission, it may be considered to configure parameters that match related characteristics of the two uplink resources for the two uplink resources, such as a time-frequency location, a code rate, a power, and the like, to make full use of uplink resources based on characteristics of different uplink resources and ensure performance of PUCCH transmission.

In the embodiments of this application, the semi-static flexible time domain unit refers to a semi-static flexible time domain unit in which a flexible duplex operation is allowed. Regarding whether there is an uplink resource occupation limitation corresponding to an uplink sub-band (UL sub-band) in the semi-static flexible time domain unit (that is, the uplink resource should be limited within a frequency domain range corresponding to the UL sub-band), any one of the following manners may be used.

Frequency domain limitation manner 1: There is a limitation, and in the semi-static flexible time domain unit, only the frequency domain range corresponding to the UL sub-band is used as an available uplink resource.

Frequency domain limitation manner 2: There is no limitation, and in the semi-static flexible time domain unit, all the frequency domain range corresponding to an uplink Bandwidth Part (BWP) (that is, it is not limited to the frequency domain range corresponding to the UL sub-band) can be used as the available uplink resource.

A Synchronization Signal and PBCH block (SSB) time domain unit can neither be configured as the semi-static UL time domain unit nor be indicated as a dynamic UL time domain unit by a Slot Format Indicator (SFI). The time domain unit herein can be understood as a symbol, and the SSB time domain unit is, for example, an SSB symbol. In addition, the terminal does not send uplink transmission overlapping with the SSB time domain unit, and the uplink transmission may include at least one of the following: Physical Uplink Shared Channel (PUSCH) transmission, Physical Uplink Control Channel (PUCCH) transmission, Physical Random Access Channel (PRACH) transmission, Sounding Reference Signal (SRS) transmission, and the like. For example, for PUSCH/PUCCH/PRACH transmission, when it overlaps with at least one SSB time domain unit, the terminal does not send the PUSCH/PUCCH/PRACH transmission; and for SRS transmission, when it overlaps with at least one SSB time domain unit, the terminal does not send SRS transmission in an overlapped SSB time domain unit.

In the flexible duplex mode, whether the flexible duplex operation or uplink transmission may be allowed in the SSB time domain unit includes any one of the following manners.

SSB collision limitation manner 1: Keep the uplink transmission limitation, that is, the flexible duplex operation is not allowed in the SSB time domain unit, and the terminal does not send PUSCH/PUCCH/PRACH/SRS transmission overlapping with the SSB time domain unit.

For example, if there is no overlap between PUSCH/PUCCH/PRACH/SRS transmission and the SSB time domain unit, but an interval between a last time domain unit of an SSB time domain unit set and a 1^{st} time domain unit of PUSCH/PUCCH/PRACH/SRS transmission is less than a downlink to uplink conversion time (referred to as a downlink-uplink conversion time for short), or an interval between a last time domain unit of PUSCH/PUCCH/PRACH/SRS transmission and a 1^{st} time domain unit of an SSB time domain unit set is less than an uplink to downlink conversion time (referred to as an uplink-downlink conversion time for short), the terminal does not send the PUSCH/PUCCH/PRACH/SRS transmission. The SSB time domain unit set may include one or more SSB time domain units with continuous time domains.

SSB collision limitation manner 2: Remove or partially remove the uplink transmission limitation, that is, allow the flexible duplex operation in the SSB time domain unit, and when the flexible duplex operation is configured in the SSB time domain unit, allow the terminal to send PUSCH/PUCCH/PRACH/SRS transmission overlapping with the SSB time domain unit when a predefined condition is met, or send PUSCH/PUCCH/PRACH/SRS transmission not overlapping with the SSB time domain unit, but an interval between a last time domain unit of the PUSCH/PUCCH/PRACH/SRS transmission and a 1^{st} time domain unit of an SSB time domain unit set is less than the uplink-downlink conversion time, or send PUSCH/PUCCH/PRACH/SRS transmission not overlapping with the SSB time domain unit, but an interval between a 1^{st} time domain unit of the PUSCH/PUCCH/PRACH/SRS transmission and a last time domain unit of an SSB time domain unit set is less than the downlink-uplink conversion time.

For example, the predefined condition may include at least one of the following:

1) A frequency domain resource occupied by PUSCH/PUCCH/PRACH/SRS transmission does not overlap with an SSB frequency domain resource;

2) A frequency domain resource occupied by PUSCH/PUCCH/PRACH/SRS transmission is limited to a frequency domain range of a UL sub-band that is configured and exists in the SSB time domain unit;

3) PUSCH/PUCCH/PRACH/SRS transmission is transmission scheduled based on dynamic signaling; and

4) PUSCH/PUCCH transmission is in a high priority, for example, is configured or indicated as 1.

For example, when the SSB is transmitted in a semi-static UL time domain unit or a dynamic UL time domain unit indicated by Downlink Control Information (DCI) (for example, DCI format 2_0), the SSB collision limitation manner 2 may also be used for a time domain unit in which SSB transmission is located.

The following describes in detail an information configuration method and apparatus, a terminal, a network side device, and a readable storage medium provided in the embodiments of this application through some embodiments and application scenarios thereof with reference to the accompanying drawings.

Referring to FIG. 3. FIG. 3 is a flowchart of an information configuration method according to an embodiment of this application. The method is applied to a terminal. As shown in FIG. 3, the method includes the following steps.

Step 31: A terminal receives first configuration information from a network side device.

In this embodiment, in the first configuration information, at most M sets of configuration information are configured for a single PUCCH resource (for example, PUCCH Resource), and each set of configuration information corresponds to a time domain unit meeting a specific requirement; or the first configuration information includes at most N PUCCH configurations (for example, PUCCH Config), and each PUCCH configuration corresponds to a time domain unit meeting a specific requirement, where M is an integer greater than 1, and N is an integer greater than 1.

It should be noted that the configuration information can be understood as including at least one or more pieces of related configuration information in a parameter structure PUCCH-Resource, including time domain resource information (such as an index of starting symbol, a quantity of occupied symbols, and the like), frequency domain resource information (such as an index of starting Physical Resource Block (PRB), a quantity of occupied PRBs, whether to enable intra-slot frequency hopping, and an index of starting PRB corresponding to a second hop when the intra-slot frequency hopping is enabled), code domain resource information (such as a related configuration of Orthogonal Cover Code (OCC), and the like. For example, the configuration information may further include configuration information such as a code rate and a power.

The PUCCH configuration may include at least a parameter configuration for each PUCCH resource, a parameter configuration for each PUCCH resource set (such as PUCCH Resource Set), parameter configurations for various PUCCH formats, a power control parameter configuration for PUCCH transmission, a spatial relation information list configuration, and the like.

According to the information configuration method in this embodiment of this application, through the first configuration information, for PUCCH transmission, parameters that match related characteristics of different uplink resources can be configured for the different uplink resources, such as a time-frequency location, a code rate, a power, and the like, to make full use of the uplink resources based on the characteristics of the different uplink resources and ensure performance of PUCCH transmission.

For example, the time domain unit meeting a specific requirement may include a first type of time domain units and/or a second type of time domain units, the first type of time domain units includes a time domain unit with an available uplink resource in the range of an uplink BWP, and the second type of time domain units includes a time domain unit with an available uplink resource only in the range of an uplink sub-band.

It should be noted that this embodiment of this application is described by taking two types of time domain units (namely, the first type of time domain unit and the second type of time domain unit) as an example, but these descriptions can be further extended to a case in which there are more than two types of time domain units as required. In this case, it can be adjusted correspondingly to: an A^{th} type of time domain unit. Another type of time domain unit described below in this embodiment of this application refers to other types of time domain units other than a predefined type of time domain unit/specified type of time domain unit, or any type of time domain unit other than the predefined type of time domain unit/specified type of time domain unit.

For example, the first type of time domain unit may include at least one of the following: 1) Semi-static uplink time domain unit; and 2) First semi-static flexible time domain unit, where in the first semi-static flexible time domain unit, all the frequency domain range corresponding to an uplink BWP can be used as available uplink resources, that is, the frequency domain limitation manner 2 is used; and the first semi-static flexible time domain unit is a semi-static flexible time domain unit in which a flexible duplex operation is allowed.

It can be understood that when the SSB collision limitation manner 1 is used, the first semi-static flexible time domain unit herein does not include the SSB time domain unit.

For example, the second type of time domain unit may include at least one of the following.

1) Semi-static downlink time domain unit, and the semi-static downlink time domain unit herein can be understood as a semi-static DL time domain unit configured with a UL sub-band.

It can be understood that when the SSB collision limitation manner 1 is used, the semi-static DL time domain unit herein does not include the SSB time domain unit.

2) Second semi-static flexible time domain unit, where in the second semi-static flexible time domain unit, a frequency domain range corresponding to only an uplink sub-band is able to be used as the available uplink resource, that is, the frequency domain limitation manner 1 is used; and the second semi-static flexible time domain unit is a semi-static flexible time domain unit in which a flexible duplex operation is allowed.

It can be understood that when the SSB collision limitation manner 1 is used, the second semi-static flexible time domain unit herein does not include the SSB time domain unit.

In this embodiment of this application, the first configuration information may be configured in different configuration manners, and descriptions are as follows.

### Configuration Manner 1

In this configuration manner, at most M sets of configuration information are configured for a single PUCCH resource in the first configuration information. For example, each BWP corresponds to a single PUCCH configuration, or each physical layer priority of each BWP corresponds to a single PUCCH configuration. At most M sets of configuration information are configured for a single PUCCH resource in this PUCCH configuration, and each set of configuration information corresponds to or is applied to a time domain unit that meets a specific requirement.

For example, the network side device may configure a single set of configuration information or two sets of configuration information for a single PUCCH resource. In a case that two sets of configuration information are configured for a single PUCCH resource, and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units. However, in a case that only a single set of configuration information is configured for a single PUCCH resource, for example, only a first set of configuration information or a second set of configuration information is configured, the single set of configuration information corresponds to the first type of time domain units or the second type of time domain units. A quantity of sets of configuration information configured for different PUCCH resources may be the same or different. When only a single set of configuration information is configured for each PUCCH resource in more than one PUCCH resource, these PUCCH resources may all be configured with only the first set of configuration information or the second set of configuration information, or at least one PUCCH resource is configured with only the first set of configuration information, and other PUCCH resources are configured with only the second set of configuration information.

Based on the configuration information configured for a single PUCCH resource, the following cases may be used for corresponding processing.

Case 1: Only a single set of configuration information is configured for a single PUCCH resource, for example, only the first set of configuration information or the second set of configuration information is configured.

In this case, the configured single set of configuration information may correspond to or may be applied to a predefined type of time domain unit by default. For example, when only the first set of configuration information is configured, the predefined type of time domain unit may be the first type of time domain unit; and when only the second set of configuration information is configured, the predefined type of time domain unit may be the second type of time domain unit. For example, when only a single set of configuration information is configured, the predefined type of time domain unit is always the first type of time domain unit or the second type of time domain unit, which can be specified by a protocol or configured by higher layer signaling. It is assumed that when the predefined type of time domain unit is the first type of time domain unit, another type of time domain unit is the second type of time domain unit; and when the predefined type of time domain unit is the second type of time domain unit, another type of time domain unit is the first type of time domain unit.

For example, in this case, the terminal may determine an unavailable resource or unavailable transmission by using any one of the following manners.

(1) When a first PUCCH resource is not configured with repetition transmission, in a case that the first PUCCH resource overlaps with another type of time domain unit based on second configuration information, the terminal may perform one of the following:

determining that the first PUCCH resource is invalid or unavailable; and in this case, the terminal does not initiate corresponding PUCCH transmission, and another type of time domain unit is used as an invalid time domain unit; and

determining that the first PUCCH resource is invalid or unavailable when the first predefined condition is not met in at least one overlapped another type of time domain unit; and in this case, another type of time domain unit is used as a valid time domain unit when the first predefined condition is met, and otherwise, another type of time domain unit is used as an invalid time domain unit.

(2) When the first PUCCH resource is configured with repetition transmission, in a case that first repetition transmission (for example, a repetition time domain location) of the first PUCCH resource overlaps with another type of time domain unit based on second configuration information, and the first repetition transmission is any repetition transmission of the first PUCCH resource, the terminal may perform one of the following:

determining that the first repetition transmission is invalid/unavailable; and in this case, another type of time domain unit is used as an invalid time domain unit, and a predefined deferral mechanism may be followed to determine next available repetition transmission, that is, to determine a next available PUCCH repetition time domain location; and

determining that the first repetition transmission is invalid/unavailable when the first predefined condition is not met in at least one overlapped another type of time domain unit; in this case, another type of time domain unit is used as a valid time domain unit when the first predefined condition is met, and otherwise, another type of time domain unit is used as an invalid time domain unit; and a predefined deferral mechanism may be followed to determine next available repetition transmission, that is, to determine a next available PUCCH repetition time domain location.

The second configuration information is a single set of configuration information configured for the first PUCCH resource. A type of a time domain unit corresponding to the second configuration information is different from a type of the another type of time domain unit. For example, a time domain unit corresponding to the second configuration information belongs to the first type of time domain unit, and the another type of time domain unit is the second type of time domain unit; or a time domain unit corresponding to the second configuration information belongs to the second type of time domain unit, and the another type of time domain unit is the first type of time domain unit.

The predefined deferral mechanism is as follows: when a specific PUCCH resource is configured with repetition transmission, it is assumed that an expected quantity of times of repetition transmission is B, for a b^{th} time of repetition transmission of the PUCCH resource (b is a positive integer between 1 and B, starts from a value of 1, and gradually increases based on a step of 1 in a transmission process corresponding to the PUCCH resource), if in a specific

PUCCH slot, repetition transmission determined based on configuration information applied on the PUCCH resource overlaps with at least one semi-static DL time domain unit (namely, a time domain unit configured as downlink by higher layer signaling TDD-UL-DL-ConfigCommon and/or TDD-UL-DL-ConfigDedicated; and regardless of whether there is an uplink sub-band in the time domain unit) and/or an SSB time domain unit (that is, at least one of time domain units occupied by the repetition transmission is the semi-static DL time domain unit and/or the SSB time domain unit), the repetition transmission in the PUCCH slot is ignored, and in a next PUCCH slot of the PUCCH slot, repetition transmission is continued to be determined based on the configuration information applied on the PUCCH resource, and an overlapping situation with the semi-static DL time domain unit and/or the SSB time domain unit is judged. This cycle is performed until the repetition transmission determined in a PUCCH slot does not overlap with the semi-static DL time domain unit and/or the SSB time domain unit, and the repetition transmission determined in the PUCCH slot is determined as the b^{th} time of repetition transmission of the PUCCH resource. After the b^{th} time of repetition transmission of the PUCCH resource is determined: when b<B, add 1 to the value of b, and continue to determine the b^{th} time of repetition transmission of the PUCCH resource based on the above operation steps; and when b=B, all B times of repetition transmission of the PUCCH resource have been determined, so the transmission operation of the PUCCH resource ends.

It should be noted that the overlapping in (1) can be understood as that at least one of time domain units occupied by the first PUCCH resource is another type of time domain unit. For collision processing between the first PUCCH resource and a time domain unit other than the first/second type of time domain unit in this application, a predefined method may be used. For example, if PUCCH transmission corresponding to the first PUCCH resource overlaps with at least one semi-static DL time domain unit (namely, a time domain unit configured as downlink by higher layer signaling TDD-UL-DL-ConfigCommon and/or TDD-UL-DL-ConfigDedicated; and regardless of whether there is an uplink sub-band in the time domain unit) and/or an SSB time domain unit (that is, at least one of time domain units occupied by the repetition transmission is the semi-static DL time domain unit and/or the SSB time domain unit), it is determined that the first PUCCH resource is invalid or unavailable. The overlapping in (2) can be understood as that at least one of time domain units occupied by the first repetition transmission is another type of time domain unit. For collision processing between the first repetition transmission and a time domain unit other than the first/second type of time domain unit in this application, a predefined method may be used, as described above. A time domain unit herein other than that is described above may include a semi-static DL time domain unit that is not configured with a UL sub-band, and/or a semi-static flexible time domain unit in which a flexible duplex operation is not allowed.

For example, for a dynamically indicated first PUCCH resource (that is, DCI indicates PUCCH transmission corresponding to the first PUCCH resource), when the PUCCH transmission corresponding to the first PUCCH resource is determined by using third configuration information, the terminal does not expect the first PUCCH resource (this corresponds to that repetition transmission is not configured) or second repetition transmission of the first PUCCH resource (this corresponds to that repetition transmission is configured) to overlap with another type of time domain unit; or when the first PUCCH resource (this corresponds to that repetition transmission is not configured) or second repetition transmission of the first PUCCH resource (this corresponds to that repetition transmission is configured) overlaps with another type of time domain unit, the terminal does not expect that a first predefined condition is not met in at least one overlapped another type of time domain unit. The third configuration information is a single set of configuration information configured for the first PUCCH resource, and the second repetition transmission is any repetition transmission of the first PUCCH resource. A type of a time domain unit corresponding to the third configuration information is different from a type of the another type of time domain unit. For example, a time domain unit corresponding to the third configuration information is the first type of time domain unit, and the another type of time domain unit is the second type of time domain unit; or a time domain unit corresponding to the third configuration information is the second type of time domain unit, and the another type of time domain unit is the first type of time domain unit.

For example, the first predefined condition may include at least one of the following:

the another type of time domain unit is the first type of time domain unit; and

when the another type of time domain unit is the second type of time domain unit, the first PUCCH resource (this corresponds to that repetition transmission is not configured) or any Resource Element (RE) occupied by repetition transmission of the first PUCCH resource (this corresponds to that repetition transmission is configured) in the overlapped another type of time domain unit is located in a frequency domain range corresponding to an uplink sub-band.

Case 2: Two sets of configuration information are configured for a single PUCCH resource, for example, the first set of configuration information and the second set of configuration information are configured.

In this case, for a single PUCCH resource, the terminal may determine applied configuration information from the configured two sets of configuration information based on at least one of the following.

1) a type of a time domain unit in which the single PUCCH resource (this corresponds to that repetition transmission is not configured) is located, or a type of a time domain unit in which repetition transmission of the single PUCCH resource (this corresponds to that repetition transmission is configured) is located. That is, the applied configuration information is determined based on a type of a time domain unit in which the single PUCCH resource (this corresponds to that repetition transmission is not configured) is located, or a type of a time domain unit in which repetition transmission of the single PUCCH resource (this corresponds to that repetition transmission is configured) is located.

For example, when a time domain unit in which a specific PUCCH resource (this corresponds to that repetition transmission is not configured) is located or a time domain unit in which repetition transmission of the PUCCH resource (this corresponds to that repetition transmission is configured) is located is the first type of time domain unit, a first set of configuration information configured for the PUCCH resource is applied; and when a time domain unit in which a specific PUCCH resource (this corresponds to that repetition transmission is not configured) is located or a time domain unit in which repetition transmission of the PUCCH resource (this corresponds to that repetition transmission is configured) is located is the second type of time domain unit, a second set of configuration information configured for the PUCCH resource is applied. For example, a mapping relationship between a time domain unit type and configuration information may be specified by a protocol or configured by higher layer signaling.

For example, when the applied configuration information is determined based on the type of the time domain unit in which repetition transmission of the PUCCH resource is located, each repetition transmission of the PUCCH resource may meet at least one of the following, to ensure a repeated merging operation when polar coding is used:

including a same quantity of REs;

including a same quantity of REs for carrying Uplink Control Information (UCI), that is, an RE used to carry a Demodulation Reference Signal (DM-RS) is not considered; and

occupying a same quantity of time domain units.

It should be noted that each repetition transmission described above is, for example, an actual repetition transmission. Each repetition transmission described above corresponds to a corresponding PUCCH resource.

For example, to ensure the repeated merging operation when polar coding is used, for a PUCCH resource configured with repetition transmission, the terminal may determine applied configuration information from the configured two sets of configuration information based on at least one of the following:

a type of a nominal time domain unit of the PUCCH resource; and

a type of a time domain unit in which 1^{st} actually initiated repetition transmission of the PUCCH resource is located.

It should be noted that for the PUCCH resource configured with repetition transmission, it can be understood that a PUCCH format corresponding to the PUCCH resource is configured with a corresponding parameter, for example, a quantity of slots nrofSlots, and a value is greater than 1, and/or a dynamic repetition factor is configured for the PUCCH resource, and a value is greater than 1. The nominal time domain unit of the PUCCH resource can be understood as: based on a higher layer signaling configuration or a DCI indication, a time domain unit in which PUCCH transmission corresponding to the PUCCH resource is located (repetition transmission is not configured), or a starting time domain unit of PUCCH transmission corresponding to the PUCCH resource (repetition transmission is configured). The time domain unit herein may be a slot, a sub-slot, or the like.

Considering that in the nominal time domain unit of PUCCH transmission, PUCCH repetition transmission may be dropped (drop) due to UCI multiplexing/prioritization rules, or postponed (postpone) due to collision with an invalid time domain unit, the applied configuration information may be determined based on a type of a time domain unit in which 1^{st} actually initiated repetition transmission of the PUCCH resource is located. After the applied configuration information is determined for PUCCH transmission, the determined configuration information is applied to subsequent repetition transmission of the PUCCH transmission.

2) First higher layer signaling, that is, the applied configuration information is configured by higher layer signaling.

In 2), in higher layer signaling configured to use a PUCCH resource, a set of configuration information of the PUCCH resource that is to be applied may be configured.

For example, a Semi-Persistent Scheduling (SPS) Hybrid Automatic Repeat reQuest Acknowledgement (HARQ-ACK) may be configured uniformly for the terminal, or an additional parameter is used in SPS-Config to indicate applied configuration information of PUCCH Resource corresponding to a parameter of n1PUCCH-AN in SPS-Config; or is configured uniformly for the terminal or each PUCCH cell or each PUCCH BWP (namely, a specific UL BWP on a specific PUCCH cell, and the UL BWP may correspond to one or more pieces of PUCCH Config), or an additional parameter is used in sps-PUCCH-AN-List-r16 in a higher layer parameter PUCCH-Config to uniformly indicate applied configuration information of each PUCCH Resource in a list, or an additional parameter is used in each list record of sps-PUCCH-AN-List-r16 in PUCCH-Config to indicate applied configuration information of PUCCH Resource corresponding to a record field sps-PUCCH-AN-ResourceID-r16 in the list.

For Scheduling Request (SR) PUCCH transmission, applied configuration information may be configured uniformly for the terminal or each PUCCH cell or each PUCCH BWP or each PUCCH Config, or an additional parameter is used in a higher layer parameter SchedulingRequestResourceConfig to indicate applied configuration information of PUCCH Resource corresponding to a resource parameter in SchedulingRequestResourceConfig.

For Channel State Information (CSI) PUCCH transmission, such as periodic CSI, applied configuration information may be uniformly configured for the terminal or each PUCCH cell, or in pucch-CSI-ResourceList in periodic in reportConfigType in a higher layer parameter CSI-ReportConfig, an additional parameter is used to uniformly indicate applied configuration information of PUCCH Resource corresponding to each PUCCH BWP configured with PUCCH Resource on a PUCCH cell, or in each list record (corresponding to a single PUCCH BWP of the PUCCH cell, and indicated by a field uplinkBandwidthPartId) of pucch-CSI-ResourceList in periodic in reportConfigType in a higher layer parameter CSI-ReportConfig, an additional parameter is used to indicate applied configuration information of PUCCH Resource corresponding to a record field pucch-Resource in the list.

For CSI PUCCH transmission, such as semi-persistent CSI, applied configuration information may be uniformly configured for the terminal or each PUCCH cell, or in pucch-CSI-ResourceList in semiPersistentOnPUCCH in reportConfigType in a higher layer parameter CSI-ReportConfig, an additional parameter is used to uniformly indicate applied configuration information of PUCCH Resource corresponding to each PUCCH BWP configured with PUCCH Resource on a PUCCH cell, or in each list record (corresponding to a single PUCCH BWP of the PUCCH cell, and indicated by a field uplinkBandwidthPartId) of pucch-CSI-ResourceList in semiPersistentOnPUCCH in reportConfigType in a higher layer parameter CSI-ReportConfig, an additional parameter is used to indicate applied configuration information of PUCCH Resource corresponding to a record field pucch-Resource in the list.

3) First DCI, that is, applied configuration information is determined based on DCI.

In 3), which set of configuration information of the PUCCH resource is applied can be determined based on downlink dynamic scheduling DCI and/or SPS activation DCI.

For example, when the applied configuration information is determined based on first DCI, the applied configuration information may be implicitly determined or explicitly indicated by using any one of the following.

(1) Implicitly determine applied configuration information

For example, the applied configuration information is corresponding to a type of a time domain unit in which PUCCH transmission indicated by the first DCI is located. This can be understood as a special case of determining the applied configuration information based on a nominal time domain unit (indicated by DCI) of PUCCH transmission. For example, if a time domain unit in which PUCCH transmission carrying HARQ-ACK feedback is located or initiates, and a PUCCH resource corresponding to the PUCCH transmission are indicated in the first DCI, for the PUCCH resource, configuration information corresponding to a type of the time domain unit in which the PUCCH transmission is located or initiates is applied.

(2) Explicitly indicate applied configuration information

For example, which set of configuration information of the PUCCH resource is applied can be explicitly indicated by an indicator field in the first DCI. The applied configuration information may meet any one of the following:

being indicated by a first indicator field in the first DCI, that is, the applied configuration information is indicated by an independent indicator field in the first DCI. For example, whether the first indicator field in the first DCI exists can be configured by higher layer signaling. When the first indicator field does not exist, default configuration information (for example, the first set of configuration information) is applied; and when the first indicator field exists, a corresponding quantity of bits may be ceiling (log 2(M)), and ceiling represents a rounding up operation, such as 1 bit when M=2;

a PUCCH resource indication PRI and the applied configuration information are jointly indicated by a second indicator field in the first DCI, where a quantity of bits occupied by a joint indicator field may be expanded as required relative to a quantity of bits occupied by a PRI indicator field; and

K1 and the applied configuration information are jointly indicated by a third indicator field in the first DCI, where a quantity of bits occupied by a joint indicator field may be expanded as required relative to a quantity of bits occupied by a KI indicator field.

It should be noted that, for 2) and 3), the terminal always uses configured/indicated configuration information for the PUCCH resource.

It is assumed that a configured/indicated single set of configuration information corresponds to/is applied to a specified type of time domain unit, for example, when it is configured/indicated to use the first set of configuration information, the specified type of time domain unit is the first type of time domain unit, and when it is configured/indicated to use the second set of configuration information, the specified type of time domain unit is the second type of time domain unit. For example, a mapping relationship between a time domain unit type and configuration information may be specified by a protocol or configured by higher layer signaling. It is assumed that when the specified type of time domain unit is the first type of time domain unit, another type of time domain unit is the second type of time domain unit; and when the specified type of time domain unit is the second type of time domain unit, another type of time domain unit is the first type of time domain unit.

For example, in a case that a single PUCCH resource is configured with two sets of configuration information, the terminal may determine an unavailable resource/unavailable transmission by using any one of the following manners.

(1) When a first PUCCH resource is not configured with repetition transmission, in a case that the first PUCCH resource overlaps with another type of time domain unit based on second configuration information, the terminal may perform one of the following:

determining that the first PUCCH resource is invalid/unavailable; and in this case, the terminal does not initiate corresponding PUCCH transmission, and another type of time domain unit is used as an invalid time domain unit; and

determining that the first PUCCH resource is invalid/unavailable when the first predefined condition is not met in at least one overlapped another type of time domain unit; and in this case, another type of time domain unit is used as a valid time domain unit when the first predefined condition is met, and otherwise, another type of time domain unit is used as an invalid time domain unit.

(2) When the first PUCCH resource is configured with repetition transmission, in a case that first repetition transmission (for example, a repetition time domain location) of the first PUCCH resource overlaps with another type of time domain unit based on second configuration information, and the first repetition transmission is any repetition transmission of the first PUCCH resource, the terminal may perform one of the following:

determining that the first repetition transmission is invalid/unavailable; and in this case, another type of time domain unit is used as an invalid time domain unit, and an existing deferral mechanism may be followed to determine next available repetition transmission, that is, to determine a next available PUCCH repetition time domain location; and

determining that the first repetition transmission is invalid/unavailable when the first predefined condition is not met in at least one overlapped another type of time domain unit; in this case, another type of time domain unit is used as a valid time domain unit when the first predefined condition is met, and otherwise, another type of time domain unit is used as an invalid time domain unit; and a predefined deferral mechanism may be followed, as described above, to determine next available repetition transmission, that is, to determine a next available PUCCH repetition time domain location.

The second configuration information is a set of configuration information determined from two sets of configuration information configured for the first PUCCH resource. For example, any one of 1), 2), and 3) can be used to determine the set of configuration information. For example, 1) is used herein, which can be understood as that for a PUCCH resource configured with repetition transmission, the terminal determines applied configuration information from two sets of configured configuration information. A type of a time domain unit corresponding to the second configuration information is different from a type of the another type of time domain unit. For example, a time domain unit corresponding to the second configuration information belongs to the first type of time domain unit, and the another type of time domain unit is the second type of time domain unit; or a time domain unit corresponding to the second configuration information belongs to the second type of time domain unit, and the another type of time domain unit is the first type of time domain unit.

It should be noted that the overlapping in (1) can be understood as that at least one of time domain units occupied by the first PUCCH resource is another type of time domain unit. For collision processing between the first PUCCH resource and a time domain unit other than the first/second type of time domain unit in this application, a predefined method may be used, refer to the previous description. The overlapping in (2) can be understood as that at least one of time domain units occupied by the first repetition transmission is another type of time domain unit. For collision processing between the first repetition transmission and a time domain unit other than the first/second type of time domain unit in this application, a predefined method may be used, refer to the previous description. A time domain unit herein other than that is described above may include a semi-static DL time domain unit that is not configured with a UL sub-band, and/or a semi-static flexible time domain unit in which a flexible duplex operation is not allowed.

For example, when using SPS-Config/SchedulingRequestResourceConfig/CSI-ReportConfig in a PUCCH resource (it is assumed to support Repetition) to configure a second set of configuration information (corresponding to the second type of time domain unit) using the PUCCH resource, it is assumed that an n^{th} PUCCH repetition of the PUCCH resource is actually transmitted in the second type of time domain unit, if a next candidate PUCCH repetition overlaps with the first type of time domain unit (it is assumed that a quantity of times of repetition transmission of the PUCCH resource has not reached a predefined threshold), it is regarded as having a conflict with an invalid time domain unit. A postpone operation needs to be performed based on a predefined Deferral mechanism, that is, it is determined from a next slot whether candidate PUCCH repetition in this slot conflicts with the invalid time domain unit. When all symbols occupied by the found candidate PUCCH repetition are the second type of time domain unit, the candidate PUCCH repetition can be actually transmitted.

For another example, when using SPS-Config/SchedulingRequestResourceConfig/CSI-ReportConfig in a PUCCH resource (it is assumed to support Repetition) to configure a first set of configuration information (corresponding to the first type of time domain unit) using the PUCCH resource, it is assumed that an n^{th} PUCCH repetition of the PUCCH resource is actually transmitted in the first type of time domain unit, if a next candidate PUCCH repetition overlaps with the second type of time domain unit (it is assumed that a quantity of times of repetition transmission of the PUCCH resource has not reached a predefined threshold), when a first predefined condition is met, the candidate PUCCH repetition can be actually transmitted, and otherwise, the postpone operation is continued to be performed.

For example, when a candidate PUCCH repetition conflicts with an invalid time domain unit, a drop operation may be directly performed instead of performing the postpone operation based on the predefined Deferral mechanism. When traversed candidate PUCCH repetition reaches the predefined threshold, the PUCCH transmission ends.

It can be understood that in (1) and/or (2), whether the first predefined condition is used to determine the unavailable resource/transmission may be specified by a protocol, or configured uniformly for the terminal or each PUCCH cell or each PUCCH BWP or each PUCCH Config, or independently configured for each functional configuration item such as SPS-Config/SchedulingRequestResourceConfig/CSI-ReportConfig.

For example, when the PUCCH transmission corresponding to the first PUCCH resource is determined by using third configuration information, the terminal does not expect the first PUCCH resource (this corresponds to that repetition transmission is not configured) or any repetition transmission of the first PUCCH resource (this corresponds to that repetition transmission is configured) to overlap with another type of time domain unit; or when the first PUCCH resource (this corresponds to that repetition transmission is not configured) or third repetition transmission of the first PUCCH resource (this corresponds to that repetition transmission is configured) overlaps with another type of time domain unit, the terminal does not expect that a first predefined condition is not met in at least one overlapped another type of time domain unit. The third configuration information is a set of configuration information determined from two sets of configuration information configured for the first PUCCH resource, and the third configuration information is determined based on a configuration or an indication, for example, the set of configuration information may be determined by using the manner in 2) or 3). The third repetition transmission is any repetition transmission of the first PUCCH resource. A type of a time domain unit corresponding to the third configuration information is different from a type of the another type of time domain unit. For example, a time domain unit corresponding to the third configuration information is the first type of time domain unit, and the another type of time domain unit is the second type of time domain unit; or a time domain unit corresponding to the third configuration information is the second type of time domain unit, and the another type of time domain unit is the first type of time domain unit.

For example, the first predefined condition may include at least one of the following:

the another type of time domain unit is the first type of time domain unit; and

when the another type of time domain unit is the second type of time domain unit, the first PUCCH resource (this corresponds to that repetition transmission is not configured) or any resource element (RE) occupied by repetition transmission of the first PUCCH resource (this corresponds to that repetition transmission is configured) in the overlapped another type of time domain unit is located in a frequency domain range corresponding to an uplink sub-band.

### Configuration Manner 2

In this configuration manner, the first configuration information includes at most N PUCCH configurations. For example, each BWP corresponds to at most N PUCCH configurations, or each physical layer priority (PHY priority) of each BWP corresponds to at most N PUCCH configurations, and each PUCCH configuration corresponds to/is applied to a time domain unit that meets a specific requirement.

For example, in a case that the first configuration information includes two PUCCH configurations, and the two PUCCH configurations include a first PUCCH configuration and a second PUCCH configuration, the first PUCCH configuration corresponds to the first type of time domain unit, and the second PUCCH configuration corresponds to the second type of time domain unit; or the first PUCCH configuration corresponds to the second type of time domain unit, and the second PUCCH configuration corresponds to the first type of time domain unit. It should be noted that when a single PUCCH Config is configured for each BWP, or a single PUCCH Config is configured for each PHY priority of each BWP, this configured single PUCCH Config is applied to only the first type of time domain unit, or applied to both the first type of time domain unit and the second type of time domain unit.

For example, in a case that the first configuration information includes two PUCCH configurations, the terminal may determine an applied PUCCH configuration from the configured two PUCCH configurations based on at least one of the following.

I) Type of a nominal time domain unit of PUCCH transmission, that is, an applied PUCCH configuration is determined based on a type of a nominal time domain unit of PUCCH transmission.

The nominal time domain unit of PUCCH transmission herein can be understood as: a time domain unit in which PUCCH transmission configured based on higher layer signaling or indicated by DCI (this corresponds to the case when repetition transmission is not configured), or a time domain unit in which PUCCH initial transmission is located (this corresponds to the case when repetition transmission is configured).

For example, for Dynamic Scheduling (DG) HARQ-ACK, a nominal time domain unit of PUCCH transmission carrying DG HARQ-ACK can be determined based on K1 indicated in downlink scheduling DCI and a time domain unit in which a Physical Downlink Shared Channel (PDSCH) transmission is located.

For SPS HARQ-ACK, a nominal time domain unit of PUCCH transmission carrying SPS HARQ-ACK can be determined based on K1 indicated in SPS activation DCI and a time domain unit of SPS PDSCH transmission.

For SR PUCCH transmission, a nominal time domain unit of PUCCH transmission carrying SR can be determined based on periodicityAndOffset in a higher layer parameter SchedulingRequestResourceConfig.

For CSI PUCCH transmission, such as for Periodic CSI on the PUCCH, a nominal time domain unit of PUCCH transmission carrying CSI can be determined based on a reportSlotConfig parameter in periodic in reportConfigType in CSI-ReportConfig, or for Semi-persistent CSI on the PUCCH, a nominal time domain unit of PUCCH transmission carrying CSI can be determined based on a reportSlotConfig parameter in semiPersistentOnPUCCH in reportConfigType in CSI-ReportConfig.

For another example, when the nominal time domain unit of PUCCH transmission belongs to the first type of time domain unit, a first PUCCH Config configured for a current BWP is applied, or a first PUCCH Config configured for a PHY priority of a current BWP corresponding to the PUCCH transmission is applied; and when the nominal time domain unit of PUCCH transmission belongs to the second type of time domain unit, a second PUCCH Config configured for the current BWP is applied, or a second PUCCH Config configured for a PHY priority of the current BWP corresponding to the PUCCH transmission is applied. For example, a mapping relationship between a time domain unit type and PUCCH Config may be specified by a protocol or configured by higher layer signaling. The current BWP herein can be understood as a BWP in which the PUCCH transmission is located or that is corresponding to the PUCCH transmission, and the PHY priority corresponding to this PUCCH transmission may be configured by higher layer signaling or indicated by DCI.

For example, for semi-static UCI in periodic transmission or semi-persistent transmission, a nominal time domain unit of PUCCH transmission corresponding to different transmission cycles may belong to the first type of time domain unit or the second type of time domain unit, and therefore, PUCCH Resource separately configured in the first PUCCH Config and the second PUCCH Config needs to be used.

For example, when the applied PUCCH configuration is determined based on the type of the nominal time domain unit of PUCCH transmission, for configuration of identifiers of PUCCH resources used by semi-static UCI in the first PUCCH configuration and the second PUCCH configuration, any one of the following may be met.

i) Configure only a first identifier of a PUCCH resource used in the first PUCCH configuration, and determine, based on the first identifier, an identifier of a PUCCH resource used in the second PUCCH configuration; or configure only a second identifier of a PUCCH resource used in the second PUCCH configuration, and determine, based on the second identifier, an identifier of a PUCCH resource used in the first PUCCH configuration; that is, configure only an ID of a PUCCH resource used in a specific PUCCH configuration, and an ID of a PUCCH resource used in another PUCCH configuration is derived based on the previously configured ID.

A simplest manner is to keep an existing parameter configuration structure unchanged, and a PUCCH Resource ID configured in the existing parameter configuration structure is applicable to two pieces of PUCCH Config, that is, the semi-static UCI uses the same PUCCH Resource ID in the first PUCCH Config and the second PUCCH Config.

Another optional manner is to introduce an ID offset. It is assumed that a PUCCH Resource ID configured in the existing parameter configuration structure is applicable to the first or second PUCCH Config (that is, indicating that PUCCH Resource corresponding to this configured ID in this PUCCH Config is used for transmission of this semi-static UCI), an ID of PUCCH Resource used in another PUCCH Config=configured ID+ID Offset. The ID Offset herein (for example, the value can be a non-negative integer such as 0 or 1) can be specified by a protocol or configured by higher layer signaling.

ii) Separately configure an identifier of the PUCCH resource used in the first PUCCH configuration and the second PUCCH configuration.

For example, for SPS HARQ-ACK, an ID of a corresponding PUCCH resource in the first PUCCH Config and the second PUCCH Config can be separately indicated in a parameter SPS-Config. For example, n1PUCCH-AN in the existing parameter SPS-Config corresponds to the ID of a corresponding PUCCH resource in the first PUCCH Config, and an additional parameter is introduced in SPS-Config to indicate an ID of the corresponding PUCCH resource in the second PUCCH Config. It should be noted that sps-PUCCH-AN-List-r16 in the parameter PUCCH-Config is separately configured in the first PUCCH Config and the second PUCCH Config, and no additional enhancement is needed.

For SR PUCCH transmission, a parameter SchedulingRequestResourceConfig can be separately configured in the first PUCCH Config and the second PUCCH Config as long as a parameter schedulingRequestID in the two pieces of SchedulingRequestResourceConfig is set to a same value, that is, associated with a same SR Config ID.

For CSI PUCCH transmission, such as Periodic CSI on a PUCCH, a PUCCH resource list corresponding to the first PUCCH Config and the second PUCCH Config can be separately configured in periodic in reportConfigType in a parameter CSI-ReportConfig, for example, pucch-CSI-ResourceList in periodic in reportConfigType in the existing parameter CSI-ReportConfig corresponds to an ID of a PUCCH resource configured in a first PUCCH Config of each PUCCH BWP, and an additional parameter is introduced in periodic in reportConfigType in CSI-ReportConfig to configure an ID of a PUCCH resource configured in a second PUCCH Config of each PUCCH BWP; or in each list record of pucch-CSI-ResourceList in periodic in reportConfigType in a parameter CSI-ReportConfig (corresponding to a single PUCCH BWP of a PUCCH cell, and indicated by a field uplinkBandwidthPartId), an ID of a PUCCH resource corresponding to the first PUCCH Config and the second PUCCH Config is separately configured, for example, a list record field pucch-Resource corresponds to an ID of PUCCH Resource configured in the first PUCCH Config of PUCCH BWP corresponding to the list record, and an additional parameter is introduced into the list record to configure an ID of PUCCH Resource configured in the second PUCCH Config of PUCCH BWP corresponding to the list record.

For CSI PUCCH transmission, for Semi-persistent CSI on a PUCCH, a PUCCH resource list corresponding to the first PUCCH Config and the second PUCCH Config can be separately configured in semiPersistentOnPUCCH in reportConfigType in a parameter CSI-ReportConfig, for example, pucch-CSI-ResourceList in semiPersistentOnPUCCH in reportConfigType in the existing parameter CSI-ReportConfig corresponds to an ID of a PUCCH resource configured in a first PUCCH Config of each PUCCH BWP, and an additional parameter is introduced in semiPersistentOnPUCCH in reportConfigType in CSI-ReportConfig to configure an ID of a PUCCH resource configured in a second PUCCH Config of each PUCCH BWP; or in each list record of pucch-CSI-ResourceList in semiPersistentOnPUCCH in reportConfigType in a parameter CSI-ReportConfig (corresponding to a single PUCCH BWP of a PUCCH cell, and indicated by a field uplinkBandwidthPartId), an ID of a PUCCH resource corresponding to the first PUCCH Config and the second PUCCH Config is separately configured, for example, a list record field pucch-Resource corresponds to an ID of PUCCH Resource configured in the first PUCCH Config of PUCCH BWP corresponding to the list record, and an additional parameter is introduced into the list record to configure an ID of PUCCH Resource configured in the second PUCCH Config of PUCCH BWP corresponding to the list record.

II) Second higher layer signaling, that is, an applied PUCCH configuration is configured by higher layer signaling.

In II), a to-be-used PUCCH resource configured in a specific set of PUCCH Config may be configured in higher layer signaling configured to use a PUCCH resource.

For example, SPS HARQ-ACK may be uniformly configured for the terminal, or an additional parameter is used in SPS-Config to indicate PUCCH Config in which a PUCCH resource corresponding to a n1PUCCH-AN parameter in SPS-Config is located, or to indicate which sps-PUCCH-AN-List-r16 parameter that is in PUCCH-Config and that is corresponding to PUCCH Config is used for SPS HARQ-ACK corresponding to SPS-Config. The sps-PUCCH-AN-List-r16 parameter in PUCCH-Config is separately configured in the first PUCCH Config and the second PUCCH Config.

For SR PUCCH transmission, a parameter SchedulingRequestResourceConfig can be separately configured in the first PUCCH Config and the second PUCCH Config. schedulingRequestID in the parameter SchedulingRequestResourceConfig is configured, so that a specific SR Config ID may be associated with only SchedulingRequestResourceConfig configured in a first PUCCH Config or a second PUCCH Config in a PUCCH BWP of a PUCCH cell.

For CSI PUCCH transmission, such as Periodic CSI on a PUCCH, applied PUCCH Config may be uniformly configured for the terminal or each PUCCH cell, or in pucch-CSI-ResourceList in periodic in reportConfigType in a higher layer parameter CSI-ReportConfig, an additional parameter is used to uniformly indicate PUCCH Config in which PUCCH Resource corresponding to each PUCCH BWP configured with PUCCH Resource on a PUCCH cell is located, or in each list record (corresponding to a single PUCCH BWP of the PUCCH cell, and indicated by a field uplinkBandwidthPartld) of pucch-CSI-ResourceList in periodic in reportConfigType in CSI-ReportConfig, an additional parameter is used to indicate PUCCH Config in which PUCCH Resource corresponding to a record field pucch-Resource in the list is located.

For CSI PUCCH transmission, for Semi-persistent CSI on a PUCCH, applied PUCCH Config may be uniformly configured for the terminal or each PUCCH cell, or in pucch-CSI-ResourceList in semiPersistentOnPUCCH in reportConfigType in a higher layer parameter CSI-ReportConfig, an additional parameter is used to uniformly indicate PUCCH Config in which PUCCH Resource corresponding to each PUCCH BWP configured with PUCCH Resource on a PUCCH cell is located, or in each list record (corresponding to a single

PUCCH BWP of the PUCCH cell, and indicated by a field uplinkBandwidthPartId) of pucch-CSI-ResourceList in semiPersistentOnPUCCH in reportConfigType in a higher layer parameter CSI-ReportConfig, an additional parameter is used to indicate PUCCH Config in which PUCCH Resource corresponding to a record field pucch-Resource in the list is located. III) Second DCI, that is, an applied PUCCH configuration is determined based on DCI.

In III), PUCCH Config in which a used PUCCH resource is located can be determined based on downlink dynamic scheduling DCI and/or SPS activation DCI.

For example, when the applied PUCCH configuration is determined based second DCI, the applied PUCCH configuration may be implicitly determined or explicitly indicated by using any one of the following:

### (1) Implicitly Determine an Applied PUCCH Configuration

For example, the applied PUCCH configuration is corresponding to a type of a time domain unit in which PUCCH transmission indicated by the second DCI is located. For example, if a time domain unit in which PUCCH transmission carrying HARQ-ACK feedback is located (this corresponds to that repetition transmission is not configured) or an starting time domain unit (this corresponds to that repetition transmission is configured), and a PUCCH resource corresponding to the PUCCH transmission are indicated in the second DCI, for the PUCCH resource, PUCCH Config corresponding to a type of the time domain unit in which the PUCCH transmission is located (this corresponds to the case when repetition transmission is not configured) or the starting time domain unit (this corresponds to the case when repetition transmission is configured) is applied.

### (2) Explicitly Indicate an Applied PUCCH Configuration

For example, PUCCH Config in which a used PUCCH resource is located can be explicitly indicated by an indicator field in the second DCI. The applied PUCCH configuration may meet any one of the following:

being indicated by a fourth indicator field in the second DCI, that is, the PUCCH Config is indicated by an independent indicator field in the second DCI. For example, whether the fourth indicator field in the second DCI exists can be configured by higher layer signaling; when the fourth indicator field does not exist, default PUCCH Config (for example, the first PUCCH Config) is used; and when the fourth indicator field exists, a corresponding quantity of bits may be ceiling (log 2(M)), and is 1 bit when M=2;

a PRI and the applied PUCCH configuration are jointly indicated by a fifth indicator field in the second DCI, where a quantity of bits occupied by a joint indicator field may be expanded as required relative to a quantity of bits occupied by a PRI indicator field; and

K1 and the applied PUCCH configuration are jointly indicated by a sixth indicator field in the second DCI, where a quantity of bits occupied by a joint indicator field may be expanded as required relative to a quantity of bits occupied by a PRI indicator field.

It should be noted that, for II) and III), the terminal always uses configured/indicated PUCCH Config for the PUCCH resource.

It is assumed that a configured/indicated PUCCH Config corresponds to/is applied to a specified type of time domain unit, for example, when it is configured/indicated to use the first PUCCH Config, the specified type of time domain unit is the first type of time domain unit, and when it is configured/indicated to use the second PUCCH Config, the specified type of time domain unit is the second type of time domain unit. For example, a mapping relationship between a time domain unit type and PUCCH Config may be specified by a protocol or configured by higher layer signaling. It is assumed that when the specified type of time domain unit is the first type of time domain unit, another type of time domain unit is the second type of time domain unit; and when the specified type of time domain unit is the second type of time domain unit, another type of time domain unit is the first type of time domain unit.

For example, in a case that the applied PUCCH configuration is determined based on a configuration or an indication, the terminal may determine an unavailable PUCCH resource or PUCCH transmission by using any one of the following manners.

(a) When a second PUCCH resource is not configured with repetition transmission, in a case that the second PUCCH resource overlaps with another type of time domain unit based on fourth configuration information, the terminal may perform one of the following:

determining that the second PUCCH resource is invalid/unavailable; and in this case, the terminal does not initiate corresponding PUCCH transmission, and another type of time domain unit is used as an invalid time domain unit; and

determining that the second PUCCH resource is invalid/unavailable when the second predefined condition is not met in at least one overlapped another type of time domain unit; and in this case, another type of time domain unit is used as a valid time domain unit when the second predefined condition is met, and otherwise, another type of time domain unit is used as an invalid time domain unit.

(b) When the second PUCCH resource is configured with repetition transmission, in a case that fourth repetition transmission (for example, a repetition time domain location) of the second PUCCH resource overlaps with another type of time domain unit based on fourth configuration information, and the fourth repetition transmission is any repetition transmission of the second PUCCH resource, the terminal may perform one of the following:

determining that the fourth repetition transmission is invalid/unavailable; and in this case, another type of time domain unit is used as an invalid time domain unit, and a predefined deferral mechanism may be followed, as described above, to determine next available repetition transmission, that is, to determine a next available PUCCH repetition time domain location; and

determining that the fourth repetition transmission is invalid/unavailable when the second predefined condition is not met in at least one overlapped another type of time domain unit; in this case, another type of time domain unit is used as a valid time domain unit when the second predefined condition is met, and otherwise, another type of time domain unit is used as an invalid time domain unit; and a predefined deferral mechanism may be followed, as described above, to determine next available repetition transmission, that is, to determine a next available PUCCH repetition time domain location.

The second PUCCH resource is a single PUCCH resource in the applied PUCCH configuration, and the fourth configuration information is configuration information corresponding to the second PUCCH resource in the applied PUCCH configuration. A type of a time domain unit corresponding to the applied PUCCH configuration is different from a type of the another type of time domain unit. For example, a time domain unit corresponding to the applied PUCCH configuration is the first type of time domain unit, and the another type of time domain unit is the second type of time domain unit; or a time domain unit corresponding to the applied PUCCH configuration is the second type of time domain unit, and the another type of time domain unit is the first type of time domain unit.

It should be noted that the overlapping in (a) can be understood as that at least one of time domain units occupied by the second PUCCH resource is another type of time domain unit.

For collision processing between the second PUCCH resource and a time domain unit other than the first/second type of time domain unit in this application, a predefined method may be used, as described above. The overlapping in (b) can be understood as that at least one of time domain units occupied by the second repetition transmission is another type of time domain unit. For collision processing between the second repetition transmission and a time domain unit other than the first/second type of time domain unit in this application, a predefined method may be used, as described above. A time domain unit herein other than that is described above may include a semi-static DL time domain unit that is not configured with a UL sub-band, and/or a semi-static flexible time domain unit in which a flexible duplex operation is not allowed.

For example, when the PUCCH transmission corresponding to the second PUCCH resource is determined by using fifth configuration information, the terminal does not expect the second PUCCH resource (this corresponds to that repetition transmission is not configured) or any repetition transmission of the second PUCCH resource (this corresponds to that repetition transmission is configured) to overlap with another type of time domain unit; or when the second PUCCH resource (this corresponds to that repetition transmission is not configured) or fifth repetition transmission of the second PUCCH resource (this corresponds to that repetition transmission is configured) overlaps with another type of time domain unit, the terminal does not expect that a second predefined condition is not met in at least one overlapped another type of time domain unit. The second PUCCH resource is a single PUCCH resource in the applied PUCCH configuration, the fifth configuration information is configuration information corresponding to the second PUCCH resource in the applied PUCCH configuration, and the applied PUCCH configuration is determined based on a configuration or an indication, for example, may be determined by using the manner in 2) or 3). The fifth repetition transmission is any repetition transmission of the second PUCCH resource. A type of a time domain unit corresponding to the applied PUCCH configuration is different from a type of the another type of time domain unit. For example, a time domain unit corresponding to the applied PUCCH configuration is the first type of time domain unit, and the another type of time domain unit is the second type of time domain unit; or a time domain unit corresponding to the applied PUCCH configuration is the second type of time domain unit, and the another type of time domain unit is the first type of time domain unit.

For example, the second predefined condition may include at least one of the following:

the another type of time domain unit is the first type of time domain unit; and

when the another type of time domain unit is the second type of time domain unit, the second PUCCH resource (this corresponds to that repetition transmission is not configured) or any resource element (RE) occupied by repetition transmission of the second PUCCH resource (this corresponds to that repetition transmission is configured) in the overlapped another type of time domain unit is located in a frequency domain range corresponding to an uplink sub-band.

In some embodiments, when a flexible duplex operation is not allowed in a time domain unit in which SSB transmission is located, the terminal does not send uplink transmission overlapping with the time domain unit in which the SSB transmission is located.

In some other embodiments, when a flexible duplex operation is allowed in a time domain unit in which SSB transmission is located, and the flexible duplex operation is configured in the time domain unit in which the SSB transmission is located, sending, by the terminal in a case that a third predefined condition is met, uplink transmission overlapping with the time domain unit in which the SSB transmission is located.

For example, the third predefined condition may include at least one of the following:

a frequency domain resource occupied by the uplink transmission does not overlap with a frequency domain resource occupied by the SSB transmission;

the frequency domain resource occupied by the uplink transmission is confined within a frequency domain range of an uplink sub-band, and the uplink sub-band is an uplink sub-band that is configured and exists in a time domain unit occupied by the SSB transmission;

the uplink transmission is transmission scheduled based on dynamic signaling; and

a priority of the uplink transmission is configured or indicated as a high priority.

For example, the uplink transmission may include but is not limited to PUSCH/PUCCH/PRACH/SRS transmission.

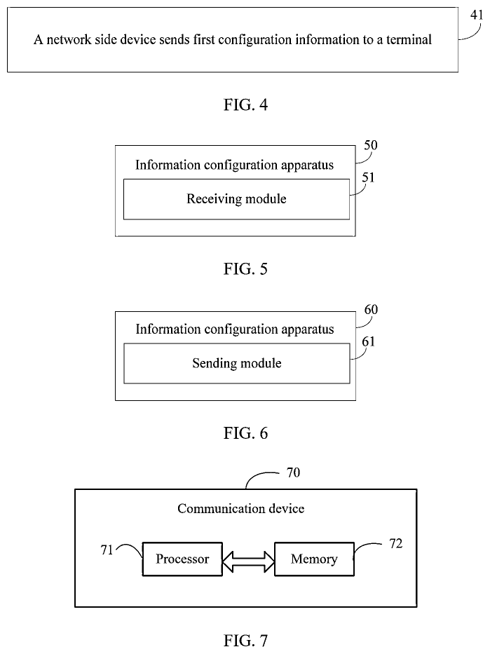

Referring to FIG. 4. FIG. 4 is a flowchart of an information configuration method according to an embodiment of this application. The method is applied to a network side device. As shown in FIG. 4, the method includes the following steps.

Step 41: The network side device sends first configuration information to a terminal.

In this embodiment, in the first configuration information, at most M sets of configuration information are configured for a single PUCCH resource (for example, PUCCH Resource), and each set of configuration information corresponds to a time domain unit meeting a specific requirement; or the first configuration information includes at most N PUCCH configurations (for example, PUCCH Config), and each PUCCH configuration corresponds to a time domain unit meeting a specific requirement, where M is an integer greater than 1, and N is an integer greater than 1.

In this way, for PUCCH transmission, parameters that match related characteristics of different uplink resources can be configured for the different uplink resources, such as a time-frequency location, a code rate, a power, and the like, to make full use of the uplink resources based on the characteristics of the different uplink resources and ensure performance of PUCCH transmission.

For example, the time domain unit meeting a specific requirement may include a first type of time domain units and/or a second type of time domain units, the first type of time domain units includes a time domain unit with an available uplink resource in the range of an uplink BWP, and the second type of time domain units includes a time domain unit with an available uplink resource only in the range of an uplink sub-band.

For example, the first type of time domain unit may include at least one of the following:

1) Semi-static uplink time domain units; and

2) First semi-static flexible time domain units, where in a first semi-static flexible time domain unit, all the frequency domain range corresponding to an uplink BWP is able to be used as the available uplink resource, that is, the frequency domain limitation manner 2 is used;

and the first semi-static flexible time domain unit is a semi-static flexible time domain unit in which a flexible duplex operation is allowed.

It can be understood that when the SSB collision limitation manner 1 is used, the first semi-static flexible time domain unit herein does not include the SSB time domain unit.

For example, the second type of time domain unit may include at least one of the following.

1) Semi-static downlink time domain units, and the semi-static downlink time domain units herein can be understood as a semi-static DL time domain unit configured with a UL sub-band.

It can be understood that when the SSB collision limitation manner 1 is used, the

semi-static DL time domain unit herein does not include the SSB time domain unit.

2) Second semi-static flexible time domain units, where in a second semi-static flexible time domain unit, a frequency domain range corresponding to only an uplink sub-band is able to be used as the available uplink resource, that is, the frequency domain limitation manner 1 is used; and the second semi-static flexible time domain unit is a semi-static flexible time domain unit in which a flexible duplex operation is allowed.

It can be understood that when the SSB collision limitation manner 1 is used, the second semi-static flexible time domain unit herein does not include the SSB time domain unit.

For example, in a case that only a single set of configuration information is configured for a single PUCCH resource, the single set of configuration information corresponds to the first type of time domain units or the second type of time domain units; or

in a case that two sets of configuration information are configured for a single PUCCH resource, and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, in a case that two sets of configuration information are configured for a single PUCCH resource, the network side device may send first higher layer signaling and/or first DCI to the terminal, where the first higher layer signaling and/or the first DCI are/is used for the terminal to determine the applied configuration information from the two sets of configuration information.

For example, the applied configuration information meets any one of the following:

being corresponding to a type of a time domain unit in which PUCCH transmission indicated by the first DCI is located;

being indicated by a first indicator field in the first DCI;

a PRI and the applied configuration information are jointly indicated by a second indicator field in the first DCI; and

K1 and the applied configuration information are jointly indicated by a third indicator field in the first DCI.

For example, in a case that the first configuration information includes two PUCCH configurations, and the two PUCCH configurations include a first PUCCH configuration and a second PUCCH configuration, the first PUCCH configuration corresponds to the first type of time domain unit, and the second PUCCH configuration corresponds to the second type of time domain unit; or the first PUCCH configuration corresponds to the second type of time domain unit, and the second PUCCH configuration corresponds to the first type of time domain unit.

For example, the network side device may send second higher layer signaling and/or second DCI to the terminal, where the second higher layer signaling and/or the second DCI are/is used for the terminal to determine the applied PUCCH configuration from the two PUCCH configurations.

For example, the applied PUCCH configuration meets any one of the following:

being corresponding to a type of a time domain unit in which PUCCH transmission indicated by the second DCI is located;

being indicated by a fourth indicator field in the second DCI;

a PRI and the applied PUCCH configuration are jointly indicated by a fifth indicator field in the second DCI; and

K1 and the applied PUCCH configuration are jointly indicated by a sixth indicator field in the second DCI.

The information configuration method provided in this embodiment of this application may be executed by an information configuration apparatus. In this embodiment of this application, an example in which the information configuration method is implemented by the information configuration apparatus is used to describe the information configuration apparatus provided in this embodiment of this application.

Referring to FIG. 5, FIG. 5 is a schematic diagram of a structure of an information configuration apparatus according to an embodiment of this application. The apparatus is used in a terminal. As shown in FIG. 5, the information configuration apparatus 50 includes:

a receiving module 51, configured to receive first configuration information from a network side device, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

For example, the time domain unit meeting a specific requirement includes a first type of time domain units and/or a second type of time domain units, the first type of time domain units includes any time domain unit with an available uplink resource in the range of an uplink BWP, and the second type of time domain units includes any time domain unit with an available uplink resource only in the range of an uplink sub-band.

For example, the first type of time domain units includes at least one of the following:

semi-static uplink time domain units; and

first semi-static flexible time domain units, where in the first semi-static flexible time domain units, all the frequency domain range corresponding to an uplink BWP is able to be used as the available uplink resource; and/or

the second type of time domain units includes at least one of the following:

semi-static downlink time domain units; and

second semi-static flexible time domain units, where in a second semi-static flexible time domain unit, a frequency domain range corresponding to only an uplink sub-band is able to be used as the available uplink resource.

For example, in a case that only a single set of configuration information is

configured for a single PUCCH resource, the single set of configuration information corresponds to the first type of time domain units or the second type of time domain units; or

in a case that two sets of configuration information are configured for a single PUCCH resource, and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, in a case that two sets of configuration information are configured for a single PUCCH resource, the information configuration apparatus 50 further includes:

a first determining module, configured to determine applied configuration information from the two sets of configuration information based on at least one of the following:

a type of a time domain unit in which the single PUCCH resource is located, or a type of a time domain unit in which repetition transmission of the single PUCCH resource is located;

first higher layer signaling; and

first downlink control information DCI.

For example, when the applied configuration information is determined based on the type of the time domain unit in which repetition transmission of the PUCCH resource is located, each repetition transmission of the PUCCH resource meets at least one of the following:

including a same quantity of RES;

including a same quantity of REs for carrying uplink control information (UCI); and

occupying a same quantity of time domain units.

For example, in a case that two sets of configuration information are configured for a single PUCCH resource, for a PUCCH resource configured with repetition transmission, the first determining module is further configured to determine applied configuration information from the two sets of configuration information based on at least one of the following:

a type of a nominal time domain unit of the PUCCH resource; and

a type of a time domain unit in which 1^{st} actually initiated repetition transmission of the PUCCH resource is located.

For example, the applied configuration information meets any one of the following:

being corresponding to a type of a time domain unit in which PUCCH transmission indicated by the first DCI is located;

being indicated by a first indicator field in the first DCI;

a PUCCH resource indication PRI and the applied configuration information are jointly indicated by a second indicator field in the first DCI; and

K1 and the applied configuration information are jointly indicated by a third indicator field in the first DCI.

For example, the information configuration apparatus 50 further includes:

a first execution module, configured to perform any one of the following:

when a first PUCCH resource is not configured with repetition transmission, in a case that the first PUCCH resource overlaps with another type of time domain unit based on second configuration information, one of the following is performed: determining that the first PUCCH resource is unavailable, and determining that the first PUCCH resource is unavailable when a first predefined condition is not met in at least one overlapped another type of time domain unit; and

when a first PUCCH resource is configured with repetition transmission, in a case that the first PUCCH resource overlaps with another type of time domain unit based on second configuration information, one of the following is performed: determining that the first repetition transmission is unavailable, and determining that the first repetition transmission is unavailable when a first predefined condition is not met in at least one overlapped another type of time domain unit, where

the second configuration information is a single set of configuration information configured for the first PUCCH resource, or the second configuration information is a set of configuration information determined from two sets of configuration information configured for the first PUCCH resource; and

a time domain unit corresponding to the second configuration information belongs to the first type of time domain unit, and the another type of time domain unit is the second type of time domain unit; or a time domain unit corresponding to the second configuration information belongs to the second type of time domain unit, and the another type of time domain unit is the first type of time domain unit.

For example, for a dynamically indicated first PUCCH resource, when PUCCH transmission corresponding to the first PUCCH resource is determined by using third configuration information, the terminal does not expect the first PUCCH resource or first repetition transmission of the first PUCCH resource to overlap with another type of time domain unit; or when the first PUCCH resource or first repetition transmission of the first PUCCH resource overlaps with another type of time domain unit, the terminal does not expect that a first predefined condition is not met in at least one overlapped another type of time domain unit, where

the third configuration information is a single set of configuration information configured for the first PUCCH resource, a time domain unit corresponding to the third configuration information is the first type of time domain unit, and the another type of time domain unit is the second type of time domain unit; or a time domain unit corresponding to the third configuration information is the second type of time domain unit, and the another type of time domain unit is the first type of time domain unit.

For example, when PUCCH transmission corresponding to a first PUCCH resource is determined by using third configuration information, the terminal does not expect the first PUCCH resource or any repetition transmission of the first PUCCH resource to overlap with another type of time domain unit; or when the first PUCCH resource or third repetition transmission of the first PUCCH resource overlaps with another type of time domain unit, the terminal does not expect that a first predefined condition is not met in at least one overlapped another type of time domain unit, where the third configuration information is a set of configuration information determined from two sets of configuration information configured for the first PUCCH resource, and the third configuration information is determined based on a configuration or an indication; and a time domain unit corresponding to the third configuration information is the first type of time domain unit, and the another type of time domain unit is the second type of time domain unit; or a time domain unit corresponding to the third configuration information is the second type of time domain unit, and the another type of time domain unit is the first type of time domain unit.

For example, the first predefined condition includes at least one of the following:

the another type of time domain unit is the first type of time domain unit; and

when the another type of time domain unit is the second type of time domain unit, the first PUCCH resource or any resource element (RE) occupied by repetition transmission of the first PUCCH resource in the overlapped another type of time domain unit is located in a frequency domain range corresponding to an uplink sub-band.

For example, in a case that the first configuration information includes two PUCCH configurations, and the two PUCCH configurations include a first PUCCH configuration and a second PUCCH configuration, the first PUCCH configuration corresponds to the first type of time domain unit, and the second PUCCH configuration corresponds to the second type of time domain unit; or the first PUCCH configuration corresponds to the second type of time domain unit, and the second PUCCH configuration corresponds to the first type of time domain unit.

For example, in a case that the first configuration information includes two PUCCH configurations, the information configuration apparatus 50 further includes:

a second determining module, configured to determine an applied PUCCH configuration from the two PUCCH configurations based on at least one of the following:

a type of a nominal time domain unit of PUCCH transmission;

second higher layer signaling; and

second DCI.

For example, when the applied PUCCH configuration is determined based on the type of the nominal time domain unit of PUCCH transmission, for configuration of identifiers of PUCCH resources used by semi-static UCI in the first PUCCH configuration and the second PUCCH configuration, at least one of the following is met:

configuring only a first identifier of a PUCCH resource used in the first PUCCH configuration, and determining, based on the first identifier, an identifier of a PUCCH resource used in the second PUCCH configuration; or configuring only a second identifier of a PUCCH resource used in the second PUCCH configuration, and determining, based on the second identifier, an identifier of a PUCCH resource used in the first PUCCH configuration; and

separately configuring an identifier of the PUCCH resource used in the first PUCCH configuration and the second PUCCH configuration.

For example, when the applied PUCCH configuration is determined from the two PUCCH configurations based on the second DCI, the applied PUCCH configuration meets any one of the following:

being corresponding to a type of a time domain unit in which PUCCH transmission indicated by the second DCI is located;

being indicated by a fourth indicator field in the second DCI;

a PRI and the applied PUCCH configuration are jointly indicated by a fifth indicator field in the second DCI; and

K1 and the applied PUCCH configuration are jointly indicated by a sixth indicator field in the second DCI.

For example, in a case that the applied PUCCH configuration is determined based on a configuration or an indication, the information configuration apparatus 50 further includes:

a second execution module, configured to perform any one of the following:

when a second PUCCH resource is not configured with repetition transmission, in a case that the second PUCCH resource overlaps with another type of time domain unit based on fourth configuration information, one of the following is performed: determining that the second PUCCH resource is unavailable, and determining that the second PUCCH resource is unavailable when a second predefined condition is not met in at least one overlapped another type of time domain unit; and

when a second PUCCH resource is configured with repetition transmission, in a case that fourth repetition transmission of the second PUCCH resource overlaps with another type of time domain unit based on fourth configuration information, one of the following is performed: determining that the fourth repetition transmission is unavailable, and determining that the fourth repetition transmission is unavailable when a second predefined condition is not met in at least one overlapped another type of time domain unit, where

the second PUCCH resource is a single PUCCH resource in the applied PUCCH configuration, the fourth configuration information is configuration information corresponding to the second PUCCH resource in the applied PUCCH configuration, a time domain unit corresponding to the applied PUCCH configuration is the first type of time domain unit, and the another type of time domain unit is the second type of time domain unit; or a time domain unit corresponding to the applied PUCCH configuration is the second type of time domain unit, and the another type of time domain unit is the first type of time domain unit.

For example, when PUCCH transmission corresponding to a second PUCCH resource is determined by using fifth configuration information, the terminal does not expect the second PUCCH resource or any repetition transmission of the second PUCCH resource to overlap with another type of time domain unit; or when the second PUCCH resource or fifth repetition transmission of the second PUCCH resource overlaps with another type of time domain unit, the terminal does not expect that a second predefined condition is not met in at least one overlapped another type of time domain unit, where the second PUCCH resource is a single PUCCH resource in the applied PUCCH configuration, the fifth configuration information is configuration information corresponding to the second PUCCH resource in the applied PUCCH configuration, and the applied PUCCH configuration is determined based on a configuration or an indication; and a time domain unit corresponding to the applied PUCCH configuration is the first type of time domain unit, and the another type of time domain unit is the second type of time domain unit; or a time domain unit corresponding to the applied PUCCH configuration is the second type of time domain unit, and the another type of time domain unit is the first type of time domain unit.

For example, the second predefined condition includes at least one of the following:

the another type of time domain unit is the first type of time domain unit; and

when the another type of time domain unit is the second type of time domain unit, the second PUCCH resource or any RE occupied by repetition transmission of the second PUCCH resource in the overlapped another type of time domain unit is located in a frequency domain range corresponding to an uplink sub-band.

For example, the information configuration apparatus 50 further includes:

a third execution module, configured to perform any one of the following:

when a flexible duplex operation is not allowed in a time domain unit in which SSB transmission is located, not sending uplink transmission overlapping with the time domain unit in which the SSB transmission is located; and

when a flexible duplex operation is allowed in a time domain unit in which SSB transmission is located, and the flexible duplex operation is configured in the time domain unit in which the SSB transmission is located, sending, in a case that a third predefined condition is met, uplink transmission overlapping with the time domain unit in which the SSB transmission is located.

For example, the third predefined condition includes at least one of the following:

a frequency domain resource occupied by the uplink transmission does not overlap with a frequency domain resource occupied by the SSB transmission;

the frequency domain resource occupied by the uplink transmission is confined within a frequency domain range of an uplink sub-band, and the uplink sub-band is an uplink sub-band that is configured and exists in a time domain unit occupied by the SSB transmission;

the uplink transmission is transmission scheduled based on dynamic signaling; and

a priority of the uplink transmission is configured or indicated as a high priority.

The information configuration apparatus 50 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The information configuration apparatus 50 provided in this embodiment of this application can implement the processes implemented in the method embodiment of FIG. 3, and a same technical effect is achieved. To avoid repetition, details are not described herein again.

Referring to FIG. 6, FIG. 6 is a schematic diagram of a structure of an information configuration apparatus according to an embodiment of this application. The apparatus is used in a network side device. As shown in FIG. 6, the information configuration apparatus 60 includes:

a sending module 61, configured to send first configuration information to a terminal, where

in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

For example, the time domain unit meeting a specific requirement may include a first type of time domain units and/or a second type of time domain units, the first type of time domain units includes a time domain unit with an available uplink resource in the range of an uplink BWP, and the second type of time domain units includes a time domain unit with an available uplink resource only in the range of an uplink sub-band.

For example, the first type of time domain unit may include at least one of the following:

1) Semi-static uplink time domain units; and

2) First semi-static flexible time domain units, where in a first semi-static flexible time domain unit, all the frequency domain range corresponding to an uplink BWP is able to be used as the available uplink resource, that is, the frequency domain limitation manner 2 is used; and the first semi-static flexible time domain unit is a semi-static flexible time domain unit in which a flexible duplex operation is allowed.

It can be understood that when the SSB collision limitation manner 1 is used, the first semi-static flexible time domain unit herein does not include the SSB time domain unit.

For example, the second type of time domain unit may include at least one of the following.

1) Semi-static downlink time domain units, and the semi-static downlink time domain units herein can be understood as a semi-static DL time domain unit configured with a UL sub-band.

It can be understood that when the SSB collision limitation manner 1 is used, the semi-static DL time domain unit herein does not include the SSB time domain unit.

2) Second semi-static flexible time domain units, where in a second semi-static flexible time domain unit, a frequency domain range corresponding to only an uplink sub-band is able to be used as the available uplink resource, that is, the frequency domain limitation manner 1 is used; and the second semi-static flexible time domain unit is a semi-static flexible time domain unit in which a flexible duplex operation is allowed.

It can be understood that when the SSB collision limitation manner 1 is used, the second semi-static flexible time domain unit herein does not include the SSB time domain unit.

For example, in a case that only a single set of configuration information is configured for a single PUCCH resource, the single set of configuration information corresponds to the first type of time domain units or the second type of time domain units; or

in a case that two sets of configuration information are configured for a single PUCCH resource, and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, in a case that two sets of configuration information are configured for a single PUCCH resource, the sending module 61 is further configured to send first higher layer signaling and/or first DCI to the terminal, where the first higher layer signaling and/or the first DCI are/is used for the terminal to determine the applied configuration information from the two sets of configuration information.

For example, the applied configuration information meets any one of the following:

being corresponding to a type of a time domain unit in which PUCCH transmission indicated by the first DCI is located;

being indicated by a first indicator field in the first DCI;

a PRI and the applied configuration information are jointly indicated by a second indicator field in the first DCI; and

K1 and the applied configuration information are jointly indicated by a third indicator field in the first DCI.

For example, in a case that the first configuration information includes two PUCCH configurations, and the two PUCCH configurations include a first PUCCH configuration and a second PUCCH configuration, the first PUCCH configuration corresponds to the first type of time domain unit, and the second PUCCH configuration corresponds to the second type of time domain unit; or the first PUCCH configuration corresponds to the second type of time domain unit, and the second PUCCH configuration corresponds to the first type of time domain unit.

For example, the sending module 61 is further configured to: send second higher layer signaling and/or second DCI to the terminal, where the second higher layer signaling and/or the second DCI are/is used for the terminal to determine the applied PUCCH configuration from the two PUCCH configurations.

For example, the applied PUCCH configuration meets any one of the following:

being corresponding to a type of a time domain unit in which PUCCH transmission indicated by the second DCI is located;

being indicated by a fourth indicator field in the second DCI;

a PRI and the applied PUCCH configuration are jointly indicated by a fifth indicator field in the second DCI; and

K1 and the applied PUCCH configuration are jointly indicated by a sixth indicator field in the second DCI.

The information configuration apparatus 60 provided in this embodiment of this application can implement the processes implemented in the method embodiment of FIG. 4, and a same technical effect is achieved. To avoid repetition, details are not described herein again.

For example, as shown in FIG. 7, an embodiment of this application further provides a communication device 70, including a processor 71 and a memory 72, and the memory 72 stores a program or an instruction that can be run on the processor 71. For example, in a case that the communication device 70 is a terminal, when the program or the instruction is executed by the processor 71, the steps of the foregoing information configuration method embodiment in FIG. 3 are implemented, and a same technical effect can be achieved. In a case that the communication device 70 is a network side device, when the program or the instruction is executed by the processor 71, the steps of the information configuration method embodiment in FIG. 4 are implemented, and a same technical effect can be achieved. To avoid repetition, details are not described herein again.

An embodiment of this application further provides a terminal, including a processor and a communication interface, where the communication interface is configured to receive first configuration information from a network side device, where in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1. The terminal embodiment is corresponding to the method embodiment on the terminal side, each implementation process and implementation of the method embodiment can be applied to the terminal embodiment, and a same technical effect can be achieved.

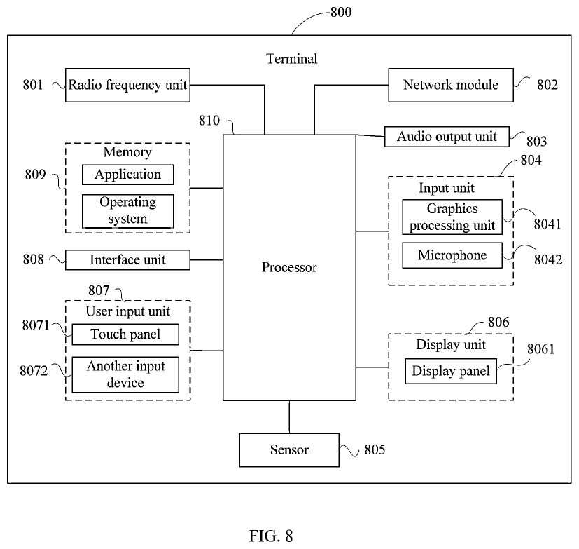

For example, FIG. 8 is a schematic diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 804 may include a Graphics Processing Unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, and an application or an instruction required by at least one function (for example, a sound playing function or an image playing function). In addition, the memory 809 may be a volatile memory or a non-volatile memory, or the memory 809 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 809 in this embodiment of this application includes but is not limited to these memories and any memory of another proper type.

The processor 810 may include one or more processing units. For example, an application processor and a modem processor are integrated into the processor 810. The application processor mainly processes an operating system, a user interface, an application, and the like. The modem processor mainly processes a wireless communication signal, for example, a baseband processor. For example, it may be understood that,, the modem processor may not be integrated into the processor 810.

The radio frequency unit 801 is configured to receive first configuration information from a network side device; and in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1.

The terminal 800 provided in this embodiment of this application can implement processes implemented in the method embodiment in FIG. 3, and a same technical effect can be achieved. To avoid repetition, details are not described herein again.

An embodiment of this application further provides a network side device, including a processor and a communication interface, where the communication interface is configured to send first configuration information to a terminal; and in the first configuration information, at most M sets of configuration information are configured for a single PUCCH resource, and each set of configuration information corresponds to a time domain unit meeting a specific requirement; or the first configuration information includes at most N PUCCH configurations, and each PUCCH configuration corresponds to a time domain unit meeting a specific requirement, where M is an integer greater than 1, and N is an integer greater than 1. This network side device embodiment is corresponding to the foregoing method embodiment of the network side device. Each implementation process and implementation of the foregoing method embodiment may be applicable to this network side device embodiment, and a same technical effect can be achieved.

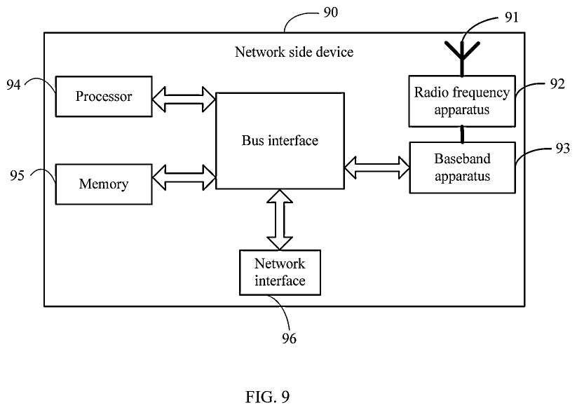

For example, an embodiment of this application further provides a network side device. As shown in FIG. 9, the network side device 90 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information through the antenna 91.

In the foregoing embodiment, the method performed by the network side device may be implemented in the baseband apparatus 93. The baseband apparatus 93 includes a baseband processor.

For example, the baseband apparatus 93 may include at least one baseband board. A plurality of chips are disposed on the baseband board. As shown in FIG. 9, one chip is, for example, a baseband processor, and is connected to the memory 95 by using a bus interface, to invoke a program in the memory 95 to perform the operations of the network device shown in the foregoing method embodiment.

The network side device may further include a network interface 96, and the interface is, for example, a Common Public Radio Interface (CPRI).

For example, the network side device 90 in this embodiment of the present disclosure further includes an instruction or a program that is stored in the memory 95 and that can be run on the processor 94. The processor 94 invokes the instruction or the program in the memory 95 to perform the method performed by the modules shown in FIG. 6, and a same technical effect is achieved. To avoid repetition, details are not described herein again.

An embodiment of this application further provides a readable storage medium. The readable storage medium stores a program or an instruction, and when the program or the instruction is executed by a processor, the processes of the information configuration method embodiment in FIG. 3 are implemented, or the processes of the information configuration method embodiment in FIG. 4 are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the information configuration method embodiment in FIG. 3 or implement the processes of the information configuration method embodiment in FIG. 4, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the information configuration method embodiment, and a same technical effect can be achieved. To avoid repetition, details are not described herein again.

An embodiment of this application further provides a communication system, including a terminal and a network side device, where the terminal may be configured to perform the steps of the information configuration method in FIG. 3, and the network side device may be configured to perform the steps of the information configuration method embodiment in FIG. 4.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information configuration method, comprising:
receiving, by a terminal, first configuration information from a network side device, wherein
in the first configuration information, at most M sets of configuration information are configured for a single Physical Uplink Control Channel (PUCCH) resource, and each set of configuration information corresponds to a time domain unit meeting a specific requirement; or the first configuration information comprises at most N PUCCH configurations, and each PUCCH configuration corresponds to a time domain unit meeting a specific requirement, wherein M is an integer greater than 1, and N is an integer greater than 1.

2. The information configuration method according to claim 1, wherein the time domain unit meeting a specific requirement comprises a first type of time domain units or a second type of time domain units, the first type of time domain units comprises a time domain unit with an available uplink resource in the range of an uplink Bandwidth Part (BWP), and the second type of time domain units comprises a time domain unit with an available uplink resource only in the range of an uplink sub-band.

3. The information configuration method according to claim 2, wherein the first type of time domain units comprises at least one of the following:
semi-static uplink time domain units; or
first semi-static flexible time domain units, wherein in a first semi-static flexible time domain unit, all the frequency domain range corresponding to an uplink BWP is able to be used as the available uplink resource; or
the second type of time domain units comprises at least one of the following:
semi-static downlink time domain units; or
second semi-static flexible time domain units, wherein in a second semi-static flexible time domain unit, only the frequency domain range corresponding to an uplink sub-band is able to be used as the available uplink resource.

4. The information configuration method according to claim 2, wherein when only a single set of configuration information is configured for a single PUCCH resource, the single set of configuration information corresponds to the first type of time domain units or the second type of time domain units; or
when two sets of configuration information are configured for a single PUCCH resource, and the two sets of configuration information comprise a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

5. The information configuration method according to claim 4, wherein when two sets of configuration information are configured for a single PUCCH resource, the method further comprises:
determining, by the terminal, applied configuration information from the two sets of configuration information based on at least one of the following:
a type of a time domain unit in which the single PUCCH resource is located, or a type of a time domain unit in which a repetition transmission of the single PUCCH resource is located;
first higher layer signaling; or
first Downlink Control Information (DCI).

6. The information configuration method according to claim 4, wherein when two sets of configuration information are configured for a single PUCCH resource, for a PUCCH resource configured with repetition transmission, the method further comprises:
determining, by the terminal, applied configuration information from the two sets of configuration information based on at least one of the following:
a type of a nominal time domain unit of the PUCCH resource; or
a type of a time domain unit in which a first actually initiated repetition transmission of the PUCCH resource is located.

7. The information configuration method according to claim 5, wherein when the applied configuration information is determined from the two sets of configuration information based on the first DCI, the applied configuration information meets any one of the following:
being corresponding to a type of a time domain unit in which a PUCCH transmission indicated by the first DCI is located;
being indicated by a first indicator field in the first DCI;
a PUCCH Resource Indication (PRI) and the applied configuration information are jointly indicated by a second indicator field in the first DCI; or K1 and the applied configuration information are jointly indicated by a third indicator field in the first DCI.

8. The information configuration method according to claim 4, wherein the method further comprises any one of the following:
when a first PUCCH resource is not configured with repetition transmission, and the first PUCCH resource overlapping with another type of time domain unit based on second configuration information, the terminal performs one of the following: determining that the first PUCCH resource is unavailable, or determining that the first PUCCH resource is unavailable when a first predefined condition is not met in at least one overlapped time domain unit of the another type; or
when a first PUCCH resource is configured with repetition transmission, and a first repetition transmission of the first PUCCH resource overlapping with another type of time domain unit based on second configuration information, the terminal performs one of the following: determining that the first repetition transmission is unavailable, or determining that the first repetition transmission is unavailable when a first predefined condition is not met in at least one overlapped time domain unit of the another type, wherein
the second configuration information is a single set of configuration information configured for the first PUCCH resource, or the second configuration information is a set of configuration information determined from two sets of configuration information configured for the first PUCCH resource; and
a time domain unit corresponding to the second configuration information belongs to the first type of time domain unit, and the another type of time domain unit is the second type of time domain unit; or a time domain unit corresponding to the second configuration information belongs to the second type of time domain unit, and the another type of time domain unit is the first type of time domain unit.

9. The information configuration method according to claim 2, wherein when the first configuration information comprises two PUCCH configurations, and the two PUCCH configurations comprise a first PUCCH configuration and a second PUCCH configuration, the first PUCCH configuration corresponds to the first type of time domain unit, and the second PUCCH configuration corresponds to the second type of time domain unit; or the first PUCCH configuration corresponds to the second type of time domain unit, and the second PUCCH configuration corresponds to the first type of time domain unit.

10. The information configuration method according to claim 1, wherein
each of the at most M sets of configuration information comprises frequency resource information, the frequency resource information comprises at least one of: an index of starting Physical Resource Block (PRB), information indicating whether to enable intra-slot frequency hopping, or an index of starting PRB corresponding to a second hop.

11. The information configuration method according to claim 1, wherein the method further comprises at least one of the following:
when a flexible duplex operation is not allowed in a time domain unit in which Synchronization Signal Block (SSB) transmission is located, skipping sending, by the terminal, an uplink transmission overlapping with the time domain unit in which the SSB transmission is located; or
when a flexible duplex operation is allowed in a time domain unit in which SSB transmission is located, and the flexible duplex operation is configured in the time domain unit in which the SSB transmission is located, in response to a third predefined condition being met, sending, by the terminal, an uplink transmission overlapping with the time domain unit in which the SSB transmission is located, wherein the third predefined condition comprises at least one of the following:
a frequency domain resource occupied by the uplink transmission does not overlap with a frequency domain resource occupied by the SSB transmission;
the frequency domain resource occupied by the uplink transmission is confined within a frequency domain range of an uplink sub-band, and the uplink sub-band is an uplink sub-band that is configured and exists in a time domain unit occupied by the SSB transmission;
the uplink transmission is a transmission scheduled based on dynamic signaling; or
a priority of the uplink transmission is configured or indicated as a high priority.

12. An information configuration method, comprising:
sending, by a network side device, first configuration information to a terminal, wherein
in the first configuration information, at most M sets of configuration information are configured for a single Physical Uplink Control Channel (PUCCH) resource, and each set of configuration information corresponds to a time domain unit meeting a specific requirement; or the first configuration information comprises at most N PUCCH configurations, and each PUCCH configuration corresponds to a time domain unit meeting a specific requirement, wherein M is an integer greater than 1, and N is an integer greater than 1.

13. The information configuration method according to claim 12, wherein the time domain unit meeting a specific requirement comprises a first type of time domain units or a second type of time domain units, the first type of time domain units comprises a time domain unit with an available uplink resource in the range of an uplink Bandwidth Part (BWP), and the second type of time domain units comprises a time domain unit with an available uplink resource only in the range of an uplink sub-band.

14. The information configuration method according to claim 13, wherein the first type of time domain unit comprises at least one of the following:
semi-static uplink time domain units; or
first semi-static flexible time domain units, wherein in a first semi-static flexible time domain unit, all the frequency domain range corresponding to an uplink BWP is able to be used as the available uplink resource; or
the second type of time domain units comprises at least one of the following:
semi-static downlink time domain units; or
second semi-static flexible time domain units, wherein in a second semi-static flexible time domain unit, only the frequency domain range corresponding to an uplink sub-band is able to be used as the available uplink resource.

15. The information configuration method according to claim 13, wherein
when that only a single set of configuration information is configured for a single PUCCH resource, the single set of configuration information corresponds to the first type of time domain units or the second type of time domain units; or
when two sets of configuration information are configured for a single PUCCH resource, and the two sets of configuration information comprise a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

16. The information configuration method according to claim 15, wherein when two sets of configuration information are configured for a single PUCCH resource, the method further comprises:
sending, by the network side device, first higher layer signaling or first Downlink Control Information (DCI) to the terminal, wherein
the first higher layer signaling or the first DCI is used for the terminal to determine the applied configuration information from the two sets of configuration information.

17. The information configuration method according to claim 16, wherein the applied configuration information meets any one of the following:
being corresponding to a type of a time domain unit in which PUCCH transmission indicated by the first DCI is located;
being indicated by a first indicator field in the first DCI;
a PRI and the applied configuration information are jointly indicated by a second indicator field in the first DCI; or
K1 and the applied configuration information are jointly indicated by a third indicator field in the first DCI.

18. A terminal, comprising a processor and a memory storing instructions, wherein the instructions, when executed by the processor, cause the processor to perform operations comprising:
receiving first configuration information from a network side device, wherein
in the first configuration information, at most M sets of configuration information are configured for a single Physical Uplink Control Channel (PUCCH) resource, and each set of configuration information corresponds to a time domain unit meeting a specific requirement; or the first configuration information comprises at most N PUCCH configurations, and each PUCCH configuration corresponds to a time domain unit meeting a specific requirement, wherein M is an integer greater than 1, and N is an integer greater than 1.

19. The terminal according to claim 18, wherein the time domain unit meeting a specific requirement comprises a first type of time domain units or a second type of time domain units, the first type of time domain units comprises a time domain unit with an available uplink resource in the range of an uplink Bandwidth Part (BWP), and the second type of time domain units comprises a time domain unit with an available uplink resource only in the range of an uplink sub-band.

20. The terminal according to claim 19, wherein the first type of time domain units comprises at least one of the following:
semi-static uplink time domain units; or
first semi-static flexible time domain units, wherein in a first semi-static flexible time domain unit, all the frequency domain range corresponding to an uplink BWP is able to be used as the available uplink resource; or
the second type of time domain units comprises at least one of the following:
semi-static downlink time domain units; or
second semi-static flexible time domain units, wherein in a second semi-static flexible time domain unit, only the frequency domain range corresponding to an uplink sub-band is able to be used as the available uplink resource.
